(19) United States
(12) Patent Application Publication
(10) Pub. No.: US 2010/0232151 A1
(43) Pub. Date: Sep. 16, 2010

(54) Permanent, Continuous, Concealable, Decorative, Christmas House Light Fixtures

(76) Inventor: Andrew Douglas Jones, Lake Stevens, WA (US)

Correspondence Address: Andrew Douglas Jones, 421 South Davies Rd., Lake Stevens, WA, 98258, US

(21) Appl. No.: 12/723,622

(22) Filed: Mar. 12, 2010

Related U.S. Application Data
(60) Provisional application No. 61/209,781, filed on Mar. 12, 2009.

(51) Int. Cl. F21V 21/00

(52) U.S. Cl. 362/217.15

(57) ABSTRACT

A decorative lighting fixture assembly with end connectors to accommodate both horizontal and vertical installation. The lighting fixture assembly includes a base channel, a wiring and bulb supporting bar, and a cover unit that is configured to snap-on to the base channel and conceal the light bulbs during off-seasons.

### CROSS-REFERENCE

Priority is claimed from the U.S. Provisional Application 61/209,781, filed on Mar. 12, 2009, entirety of which is hereby incorporated by reference.

### BACKGROUND

The present application relates to light fixture, and more particularly to decorative lighting fixture on a house.

Note that the points discussed below may reflect the hindsight gained from the disclosed inventions, and are not necessarily admitted to be prior art.

There have been many ideas to improve the placement and removal of exterior Christmas house lights. Wood in U.S. Pat. No. 5,404,279 describes a flip-open decorative hidden light trim assembly with a hinged door to obscure the internal lights, but he did not address the need for custom length section. Furthermore the hinge door would be unattractive while open and not offer the preferred look. Wood also requires that the fixture be attached only horizontally with only horizontally placed screws.

Shaffer in U.S. Pat. No. 5,813,751 offers a design for permanent installation of exterior Christmas lighting with a simple open grid pattern that standard Christmas lights can be drawn through and left in place. The decorative lights are exposed even when not used.

A simple system to just cover lights when not in use is described by Padermos in U.S. Pat. No. 6,474,840. Like Wood the system includes a housing with a door on a hinge that is used to cover the lights when not in use.

The present application provides holiday light fixture designs with novel end connectors of both standard or custom made lengths so that a home can be illuminated with ideal, even light spacing. A cover unit is snapped on to conceal and protect the installed seasonal lighting when the user deems it inappropriate to display such lighting. Lights may be permanently installed, but the design would achieve a “just hung for the season” look as opposed to exposed prefabricate run of lights hanging on the roof. The end connectors would allow installation for varying roof styles.

The need to traverse a dangerous ladder once a year in cold weather is the task of many a home owner during the holiday season can be removed from one's annual “to-do” list with the installation of the light fixtures of this application.

### BRIEF DESCRIPTION OF THE DRAWINGS

The disclosed inventions will be described with reference to the accompanying drawings, which show important sample embodiments of the invention and which are incorporated in the specification hereof by reference, wherein:

FIG. 1 is a perspective view of the base channel and the matching cover unit of an example light fixture in accordance to this application.

FIG. 2A is a perspective view of the light support bar of an example light fixture in accordance to this application.

FIG. 2B is a plan view of the swiveling end of the light support bar of an example light fixture in accordance to this application.

FIG. 3A is a cross sectional view of the light support bar and base channel assembly of one embodiment in accordance to this application.

FIG. 3B is a cross sectional view of the light support bar and base channel assembly of another embodiment in accordance to this application.

FIG. 4 a sample wire harness for situations where two light support bars do not intersect adequately.

FIG. 5 illustrates example vertical and horizontal attaching installation options in accordance to this application.

FIG. 6 illustrates an example decorative installation of lights with the light fixtures in accordance to this application.

### DETAILED DESCRIPTION OF SAMPLE EMBODIMENTS

The numerous innovative teachings of the present application will be described with particular reference to presently preferred embodiments (by way of example, and not of limitation). The present application describes several inventions, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

A decorative lighting fixture in this application is made up of three main components: The base channel, the wire and light support bar, and the cover unit for the off seasons. Once installed the bars are intended to remain permanently. During the off seasons, the cover unit is snapped into place to obscure the light bulbs.

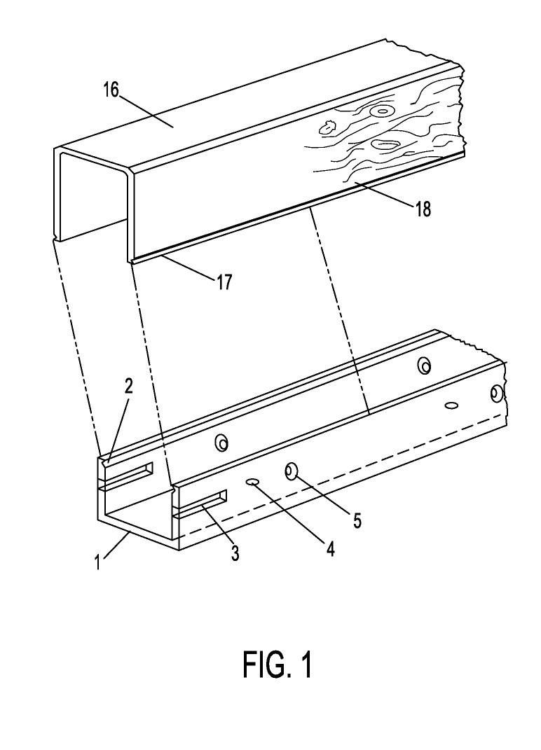

FIG. 1 illustrates an example base channel 1 and the off season cover unit 16. For both the base channel and the cover unit, three flat panels of hard material form the elongated base and side walls that form a channel to hold or cover a wire and light support bar. The base channel 1 and the cover unit 16 are rigid and a matching pair, able to be snapped together at the edge slots 2 and 17. They can be made in predefined and custom made lengths, and made of wood, metal, or plastic. Colors may be painted to match a house roof trims. The cover 16 may also be painted with varying textures, for example, a smooth and wood grain 18.

Open slots 3 are made on the side walls at each of the ends of the base channel, allowing an electrical plug to rotate 180 degrees to accommodate installation in any direction. On the base and side walls of the base channel 1, accommodating vertical and horizontal holes 4 and 5 are made for mounting the light fixture assembly to a roof trim or a building wall.

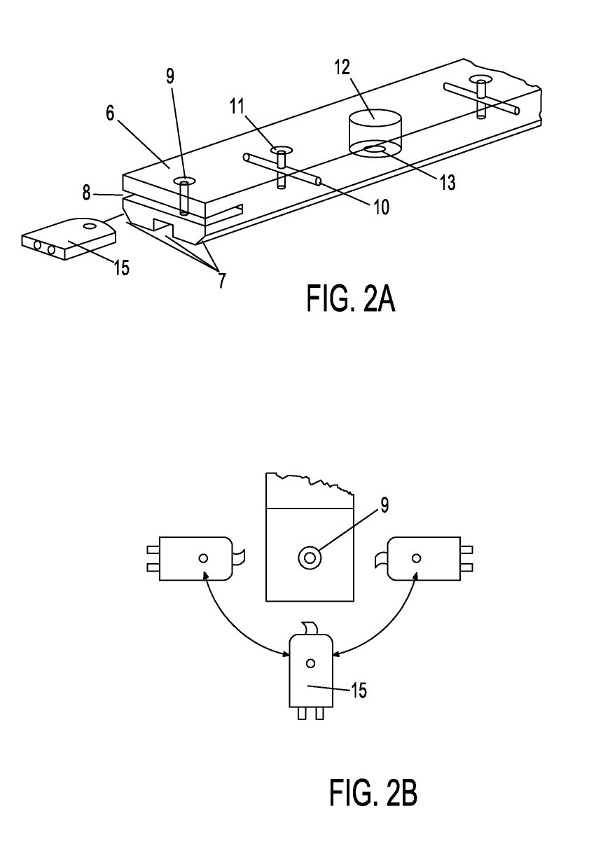

FIG. 2A illustrates an example wire and light support bar that supports the individual lighting bulbs and the electrical wires. It also has slots 8 and hole 9 at each end to support swiveling electrical connectors or plugs 15. As shown in FIG. 2B, hole 9 is used to hold an axis for a swiveling electrical plug, electrical plug 15 can rotate around the axis held through hole 9 for 180 degrees in slot 8 and slot 3 at the end of the supporting bar so that the lighting fixture assembly can be installed either horizontally or vertically.

The lighting support bar has both horizontal and vertical holes 10 and 11 that match holes 5 and 4 on the base channel so that the assembly can be secured to the side or under the house trim. Three slots 7 are provided at the lower section of the lighting bar to accommodate the wiring which connects the wire plug 15 with the individual lighting bulbs mounted in a holder hole 13. The light bar may have holder holes that accommodate 120 volt bulbs, low voltage bulbs and/or LED lights.

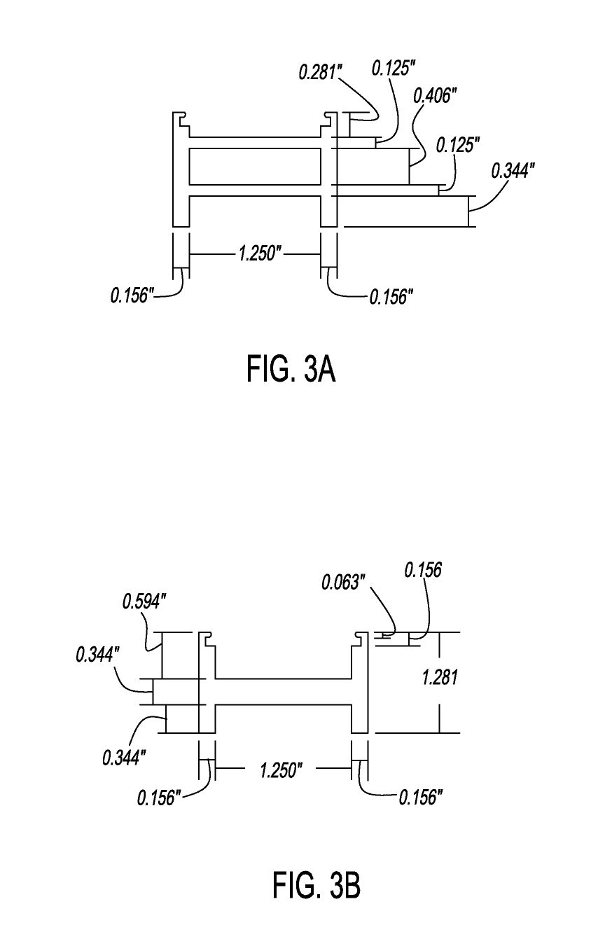

Alternatively, as shown in FIGS. 3A and 3B, the base channel and the light and wiring supporting bar may be built as one piece, and the depth and thickness of base panel may vary according to whether it is to accommodate traditional incandescent light bulbs or LED bulbs or other types of light bulbs.

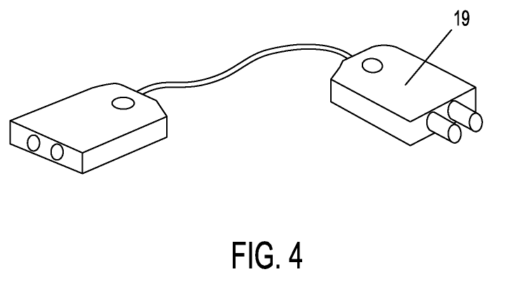

For roof lines with changing elevations where two light supporting bars in tandem do not intersect adequately, a simple wire harness 19 as shown in FIG. 4 may be used to provide flexibility.

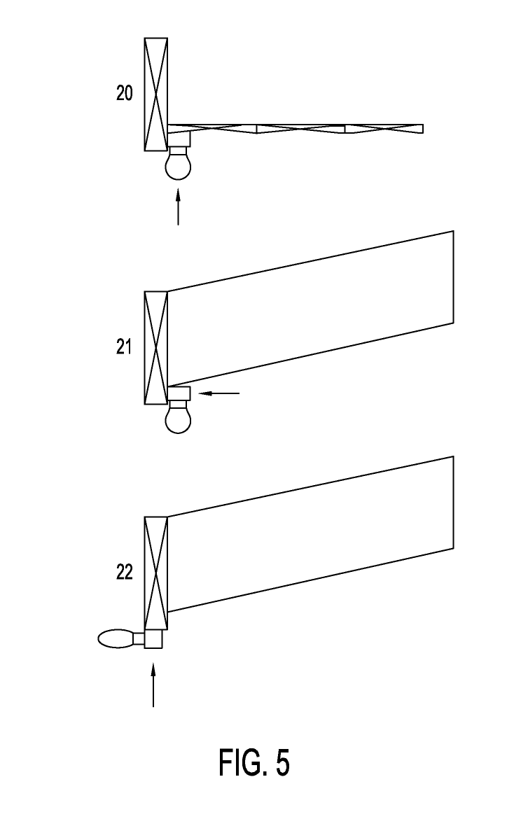

The base channel and light bar assembly can be attached to house roof both vertically and horizontally as shown in FIG. 5, secured to the side or under the house trim 20, 21, 22.

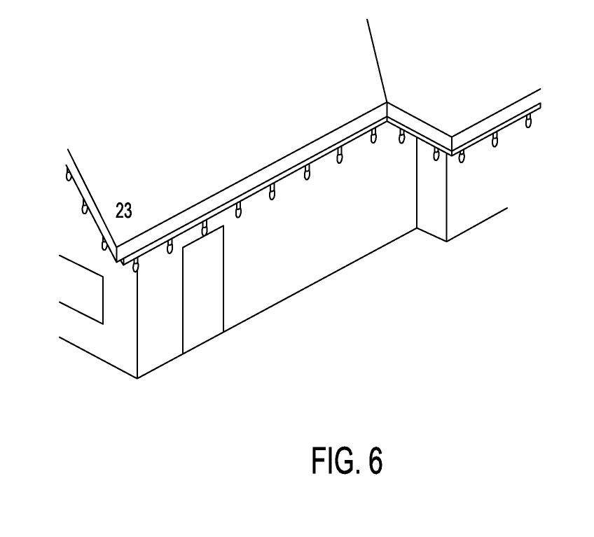

FIG. 6 illustrates a typical installation where the decorative light bulbs evenly attached to the roof trims. During off seasons, the decorative lights would not be removed, the over unit shown in FIG. 1 would be snapped onto the base channel to cover the light bulbs, providing a consistent look and feel of a roof trim.

Additional general background, which helps to show variations and implementations, may be found in U.S. Pat. No. 5,404,279, U.S. Pat. No. 5,813,751, U.S. Pat. No. 6,474,840 and U.S. Pat. No. 3,692,993, all of which are hereby incorporated by reference herein for all purposes:

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. A decorative lighting fixture, comprising:
an elongated base channel having a base panel, a first side panel and a second side panel, forming a channel with a first and a second open end, the base panel having an end edge at each end, the first and second side panels having elongated side edges and end edges at each end, wherein the side edges of said first side panel and the edges of said second side panel are configured as snap-on slots, matching open slots are cut into the end edges of the first and second panel to accommodate a electrical plug swiveling across the first and the second side panels;
an elongated lighting support bar mountable to said base channel, having at least one end configured to accommodate a swiveling electrical plug, at least one holder holes for electrical bulb and wiring support slots for holding electrical wires; and
an elongated cover unit having a cover panel, a first side panel and a second side panel, wherein said first and second side panel having side edges configured as snap-on slot that snap-on to the snap-on slots of said base channel, forming a house that conceals a mounted lighting bar and electrical bulb inside said base channel.

2. The decorative lighting fixture, wherein said lighting support bar and said base panel of the base channel are configured to be one integral piece.

3. The decorative lighting fixture, wherein said lighting support bar is configured to accommodate plurality of different types of light bulbs.

4. The decorative lighting fixture, wherein said base channel is mountable to a roof trim both horizontally and vertically.

5. The decorative lighting fixture, wherein said cover unit is painted with texture of a choice.
